(19) United States
(12) Patent Application Publication
(10) Pub. No.: US 2026/0099912 A1
(43) Pub. Date: Apr. 9, 2026

(54) ALIGNING IMAGES TO A DESIGN DURING DESIGN-BASED DEFECT DETECTION USING DEEP LEARNING IMAGE SEGMENTATION

(71) Applicant: KLA CORPORATION, Milpitas, CA (US)

(72) Inventors: Surajit Mondal, Chennai (IN); Rahul Prakash, Chennai (IN)

(21) Appl. No.: 19/083,598

(22) Filed: Mar. 19, 2025

(30) Foreign Application Priority Data
Oct. 7, 2024 (IN) 202441075765

(51) Int. Cl. G06T 7/00

(52) U.S. Cl. CPC G06T 7/001; G06T 2207/10061; G06T 2207/20084; G06T 2207/30148

(57) ABSTRACT

A binary segmented image is determined from a scanning electron beam image using a supervised deep learning image segmentation model. The binary segmented image is rendered to be binary and is segmented to include only some features of the image. The binary segmented image is matched to a region of a design image. Defect detection is performed in the image using the region of the design image.

### CROSS-REFERENCE TO RELATED APPLICATIONS

This application claims priority to the Indian patent application filed Oct. 7, 2024 and assigned App. No. 202441075765, the disclosure of which is hereby incorporated by reference.

### FIELD OF THE DISCLOSURE

This disclosure relates to workpiece inspection and, more particularly, to inspection of semiconductor wafers.

### BACKGROUND OF THE DISCLOSURE

Evolution of the semiconductor manufacturing industry is placing greater demands on yield management and, in particular, on metrology and inspection systems. Critical dimensions continue to shrink, yet the industry needs to decrease time for achieving high-yield, high-value production. Minimizing the total time from detecting a yield problem to fixing it maximizes the return-on-investment for a semiconductor manufacturer.

Fabricating semiconductor devices, such as logic and memory devices, typically includes processing a workpiece, such as a semiconductor wafer, using a large number of fabrication processes to form various features and multiple levels of the semiconductor devices. For example, lithography is a semiconductor fabrication process that involves transferring a pattern from a reticle to a photoresist arranged on a semiconductor wafer. Additional examples of semiconductor fabrication processes include, but are not limited to, chemical-mechanical polishing (CMP), etching, deposition, and ion implantation. An arrangement of multiple semiconductor devices fabricated on a single semiconductor wafer may be separated into individual semiconductor devices.

Inspection processes are used at various steps during semiconductor manufacturing to detect defects on wafers to promote higher yield in the manufacturing process and, thus, higher profits. Inspection has always been an important part of fabricating semiconductor devices such as integrated circuits (ICs). However, as the dimensions of semiconductor devices decrease, inspection becomes even more important to the successful manufacture of acceptable semiconductor devices because smaller defects can cause the devices to fail. For instance, as the dimensions of semiconductor devices decrease, detection of defects of decreasing size has become necessary because even relatively small defects may cause unwanted aberrations in the semiconductor devices.

As design rules shrink, however, semiconductor manufacturing processes may be operating closer to the limitation on the performance capability of the processes. In addition, smaller defects can have an impact on the electrical parameters of the device as the design rules shrink, which drives more sensitive inspections. As design rules shrink, the population of potentially yield-relevant defects detected by inspection grows dramatically, and the population of nuisance defects detected by inspection also increases dramatically. Therefore, more defects may be detected on the wafers, and correcting the processes to eliminate all of the defects may be difficult and expensive. Determining which of the defects actually have an effect on the electrical parameters of the devices and the yield may allow process control methods to be focused on those defects while largely ignoring others. Furthermore, at smaller design rules, process-induced failures, in some cases, tend to be systematic. That is, process-induced failures tend to fail at predetermined design patterns often repeated many times within the design. Elimination of spatially-systematic, electrically-relevant defects can have an impact on yield.

Inspection can involve comparing an image of the workpiece against a design. In previous techniques, a matching score was used to align the image against the design. This typically relied on a vision-based image alignment algorithm to align the image of the workpiece against the design. This could require many combinations to identify the correct design layers in a multi-layer design file. Manual tuning was used to correct the algorithm parameters, which was time-consuming. Failures were frequent because images of different modalities were being aligned. Improved systems and techniques are needed.

### BRIEF SUMMARY OF THE DISCLOSURE

A method is provided in a first embodiment. The method includes receiving an image of a workpiece at a processor. The image is a scanning electron beam image. A binary segmented image is determined from the image using a supervised deep learning image segmentation model. The binary segmented image is rendered to be binary and is segmented to include only some features of the image. Using the processor, the binary segmented image is matched to a region of a design image. The design image is rendered from a design of structures on the workpiece. Using the processor, defect detection in the image is performed using the region of the design image.

The method may include imaging the workpiece with an electron beam workpiece inspection tool. In an instance, the method includes generating an electron beam with an electron beam source; directing the electron beam at the workpiece; measuring electrons returned from the workpiece using a detector; and generating, using the processor, the image using signals from the detector.

The method may include training the supervised deep learning image segmentation model using a plurality of pairs of training images and corresponding training binary segmented images.

The workpiece may be a semiconductor wafer. In an instance, the image includes at least one logic structure.

An electron beam workpiece inspection tool is disclosed in a second embodiment. The electron beam workpiece inspection tool includes an electron beam source configured to generate an electron beam; a stage configured to hold a workpiece in a path of the electron beam; a detector configured to measure electrons returned from the workpiece; and a processor in electronic communication with the detector. The processor is configured to: receive an image of the workpiece; determine a binary segmented image from the image using a supervised deep learning image segmentation model; match the binary segmented image to a region of a design image; and perform defect detection in the image using the region of the design image. The image is based on signals from the detector. The binary segmented image is rendered to be binary and is segmented to include only some features of the image. The design image is rendered from a design of structures on the workpiece.

The processor may be further configured to generate the image using the signals from the detector.

The supervised deep learning image segmentation model may be trained using a plurality of pairs of training images and corresponding training binary segmented images.

The workpiece may be a semiconductor wafer. In an instance, the image includes at least one logic structure.

A non-transitory computer-readable storage medium is provided in a method embodiment. The non-transitory computer-readable storage medium includes one or more programs for executing the following steps on one or more computing devices. An image of a workpiece is received. The image is a scanning electron beam image. A binary segmented image is determined from the image using a supervised deep learning image segmentation model. The binary segmented image is rendered to be binary and is segmented to include only some features of the image. The binary segmented image is matched to a region of a design image. The design image is rendered from a design of structures on the workpiece. Defect detection in the image is performed using the region of the design image.

The steps may include sending instructions to an electron beam workpiece inspection tool to image the workpiece.

The supervised deep learning image segmentation model may be trained using a plurality of pairs of training images and corresponding training binary segmented images.

The workpiece may be a semiconductor wafer. In an instance, the image includes at least one logic structure.

### DESCRIPTION OF THE DRAWINGS

For a fuller understanding of the nature and objects of the disclosure, reference should be made to the following detailed description taken in conjunction with the accompanying drawings, in which:

FIG. 1 is a flowchart of a method in accordance with the present disclosure;

FIG. 2 includes exemplary images corresponding to the method of FIG. 1; and

FIG. 3 is a diagram of an embodiment of a workpiece inspection tool in accordance with the present disclosure.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure. Accordingly, the scope of the disclosure is defined only by reference to the appended claims.

Embodiments disclosed herein segment critical patterns in an image of a workpiece using a supervised deep learning-based image segmentation model. The segmented binary image is aligned with the design image at to achieve a robust alignment between image and design image. The results of the alignment can be used for defect detection during workpiece inspection. In an instance, inspection uses a scanning electron microscope (SEM).

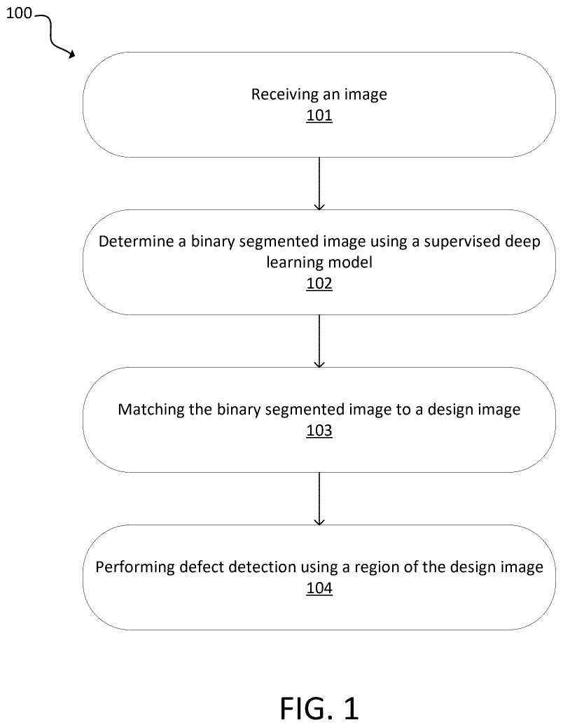

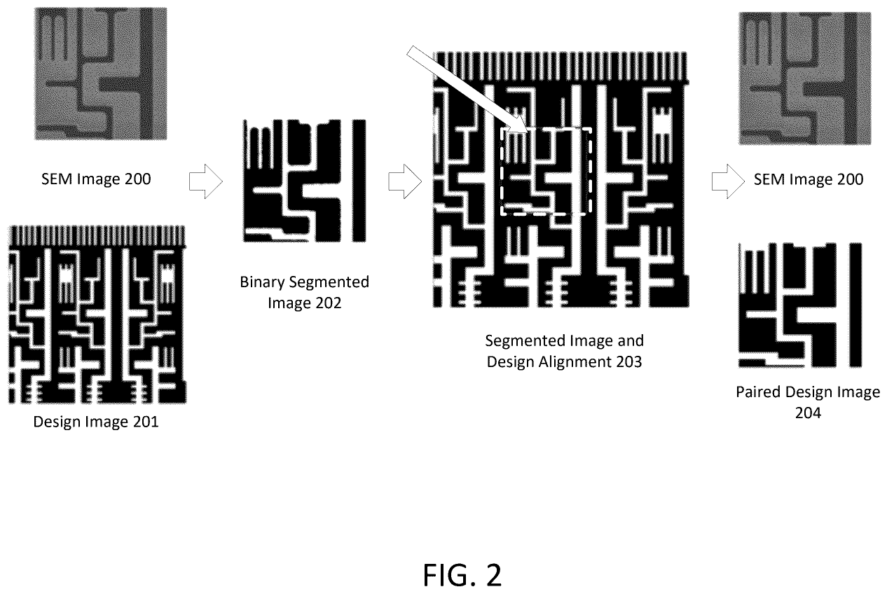

FIG. 1 is a flowchart of a method 100. FIG. 2 includes exemplary images corresponding to the method of FIG. 1. Some or all the steps of the method 100 can be performed using a processor.

In FIG. 1, an image of a workpiece is received at a processor at 101. The image can be a scanning electron beam image. In an instance, the workpiece is a semiconductor wafer. The semiconductor wafer can include at least one logic structure, though other devices are possible. An example of the image is shown in FIG. 2 with the SEM image 200. The image is only part of a surface of a semiconductor wafer.

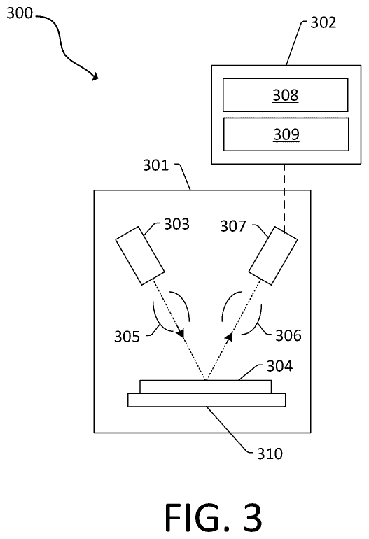

To generate the image, the workpiece can be imaged with an electron beam workpiece inspection tool, such as an SEM. This can include generating an electron beam with an electron beam source; directing the electron beam at the workpiece; measuring electrons returned from the workpiece using a detector; and generating the image using signals from the detector. Operation of the electron beam workpiece inspection tool is further described with respect to FIG. 3. The electron beam inspection tool can receive instructions to image the workpiece.

A corresponding design image for the workpiece is shown in FIG. 2 with the design image 201. The size of the design can depend on the SEM image 200. Typically, the design image 201 is larger the SEM image 200. This can account for stage uncertainties. Alignment may be needed because the design image 201 is larger than the SEM image 200. The design image 201 can be optionally segmented.

The design image, such as the design image 201, is rendered from a design of the structures on the workpiece. The design may be stored in, for example, a GDS format. Simulating (or “rendering”) the design data corresponding to parts (or “clips”) of the workpiece can be used to generate images that illustrate how the design data will be printed on the workpiece. This can simulate what the design would look like when the design is printed or fabricated on a workpiece. This can be an ideal version of the design on the workpiece. For example, rendering the design may include generating a simulated representation of a workpiece on which the polygons are printed or formed. Rendering as described above may be performed using any suitable method, algorithm, or software known in the art, such as SEMulator 3D, which is commercially available from Coventor, Inc., or PROLITH, which is commercially available from KLA Corporation. PROLITH can be used in concert with SEMulator 3D. However, rendering the design for the workpiece may be performed to generate a simulated workpiece using any suitable model(s) of any of the process(es) involved in producing actual workpieces from the design. In this manner, the design may be used to simulate what a workpiece on which the design has been formed will look like in workpiece space (i.e., not necessarily what such a workpiece would look like to an imaging system). Therefore, the design rendering may generate a simulated representation of the workpiece that may represent what the workpiece would look like in two-dimensional (2D) or three-dimensional (3D) space of the workpiece.

At 102 of FIG. 1, a binary segmented image is determined from the image using a supervised deep learning image segmentation model. An example is shown in FIG. 2 with binary segmented image 202. The binary segmented image 202 is a binary segmented image of the SEM image 200. The binary segmented image 202 is switched to binary and/or segmented to the relevant pattern, area, or structural feature(s).

Algorithms can convert an SEM image 200 to a binary segmented image 202. However, not all features are necessary for SEM image to design alignment. In the embodiments disclosed herein, the features that can provide good alignment can be selectively segmented.

The supervised deep learning image segmentation model can be trained using a plurality of pairs of training images and corresponding training binary segmented images. The supervised deep learning image segmentation model can be trained by providing a ground truth on SEM images which the supervised deep learning image segmentation model learns to segment the necessary features from a given SEM image. The image count needed for training may be based on variations in image quality and/or patterns in the SEM images.

At 103 in FIG. 1, the binary segmented image is matched to a region of a design image. An example is shown in FIG. 2. Segmented SEM and design alignment 203 shows the binary segmented image 202 on the design image 201. The white arrow and dotted line highlights the segmented SEM and design alignment 203. This is the region in the design image 201 that the binary segmented image 202 corresponds to.

The design image 201 can act as a reference channel in the deep learning-based defect detection process. Thus, the binary segmented image 202 and design image 203 are aligned before being used for defect detection. As the semiconductor industry grows, the workpiece layer patterns are becoming more intricate. For an electron beam workpiece inspection tool like an SEM, because of the high resolution, accurate alignment between the binary segmented image 202 and design image 203 will improve design-based workpiece inspection. The design image 203 is binary in nature, which can make it challenging to align with the SEM image 200 due to the complexity of the pattern in the SEM image 200. By segmenting only the required patterns of the SEM image 200 using a supervised deep learning model and creating a binary segmented image 202 for robust alignment with the design image 203, the results can be improved.

SEM images have varying contrast across the image which gives lower correlation score when matched with a binary design image. Matching a binary image on a binary image provides a higher matching score. In an instance, the supervised deep learning based image segmentation model can perform the alignment of the image 202 and design image 203. In another instance, a vision-based image alignment algorithm can perform the alignment.

The supervised deep learning based image segmentation model can segment the patterns of interest from SEM image 200 to generate the binary segmented image 202. A deep learning based image segmentation model is trained based on ground truth provided by a user. The deep learning based image segmentation model can generate a prediction map by assigning a probability score to each pixel in an image and only the pixels having probability value higher than a user assigned threshold value are used for segmenting the features.

The pattern of interest can be selected based on the polygons visible in the design image 201. The binary segmented image 202 is moved over the design image 201 and matched to corresponding design patterns based on its correlation score generated by, for example, a computer vision algorithm. The segmented SEM image can be based on a binary design image and correlation coefficient/scores can be generated for each position. A correlation score is a number between −1 and 1 that indicates the strength of a relationship between variables. The best correlation score is selected as final match position for alignment. As both the binary segmented image 202 and the design image 201 are binary images, the matching becomes robust and requires fewer interventions from a user. After the SEM image 200 and the design image 201 are aligned using the binary segmented image 202, the SEM image 200 and the design image 201 can be used for defect detection. In an instance, only the region of the design image 201 corresponding to the aligned binary segmented image 202 (i.e., the same region as shown in the SEM image 200) is used during defect detection. Part of the design image 201 can be selected for the defect detection.

At 104 in FIG. 1, defect detection in the image is performed using the region of the design image. An example is shown in FIG. 2. The paired design image 204 is the region of the design image 201 that corresponds to the binary segmented image 202. This paired design image 204 can be compared against SEM image 200 to perform defect detection. For example, image subtraction can be performed using the paired design image 204 and the SEM image 200. In another example, the paired design image is sent as reference channel along with the SEM image in a deep learning-based defect detection algorithm. The deep learning-based defect detection algorithm may be different from the deep learning based image segmentation model.

Embodiments of the method 100 can enable easier segmentation using the polygons visible in the design image 201. Defect detection is less time-consuming because less manual tuning of parameters is needed when there are multiple layers in the design image. Robust alignment can be attained even for intricate or complex patterns on the workpiece. This results to improved alignment success rates.

FIG. 3 is a block diagram of an embodiment of a system 300. The system 300 includes a workpiece inspection tool (which includes the electron column 301) configured to generate images of a workpiece 304. For example, the system 300 can generate the SEM image 200 in FIG. 2.

The workpiece inspection tool in FIG. 3 includes an output acquisition subsystem that includes at least an energy source and a detector. The output acquisition subsystem may be an electron beam-based output acquisition subsystem. For example, in one embodiment, the energy directed to the workpiece 304 includes electrons, and the energy detected from the workpiece 304 includes electrons. In this manner, the energy source may be an electron beam source. In one such embodiment shown in FIG. 3, the output acquisition subsystem includes electron column 301, which is coupled to computer subsystem 302. A stage 310 may hold the workpiece 304.

As also shown in FIG. 3, the electron column 301 includes an electron beam source 303 configured to generate electrons that are focused to workpiece 304 by one or more elements 305. The electron beam source 303 may include, for example, a cathode source or emitter tip. The one or more elements 305 may include, for example, a gun lens, an anode, a beam limiting aperture, a gate valve, a beam current selection aperture, an objective lens, and a scanning subsystem, all of which may include any such suitable elements known in the art.

Electrons returned from the workpiece 304 (e.g., secondary electrons) may be focused by one or more elements 306 to detector 307. One or more elements 306 may include, for example, a scanning subsystem, which may be the same scanning subsystem included in element(s) 305.

The electron column 301 also may include any other suitable elements known in the art.

Although the electron column 301 is shown in FIG. 3 as being configured such that the electrons are directed to the workpiece 304 at an oblique angle of incidence and are scattered from the workpiece 304 at another oblique angle, the electron beam may be directed to and scattered from the workpiece 304 at any suitable angles. In addition, the electron beam-based output acquisition subsystem may be configured to use multiple modes to generate images of the workpiece 304 (e.g., with different illumination angles, collection angles, etc.). The multiple modes of the electron beam-based output acquisition subsystem may be different in any image generation parameters of the output acquisition subsystem.

Computer subsystem 302 may be coupled to detector 307 as described above. The detector 307 may detect electrons returned from the surface of the workpiece 304 thereby forming electron beam images of the workpiece 304. The electron beam images may include any suitable electron beam images. Computer subsystem 302 may be configured to perform any of the functions described herein using the output of the detector 307 and/or the electron beam images. Computer subsystem 302 may be configured to perform any additional step(s) described herein. A system 300 that includes the output acquisition subsystem shown in FIG. 3 may be further configured as described herein.

It is noted that FIG. 3 is provided herein to generally illustrate a configuration of an electron beam-based output acquisition subsystem that may be used in the embodiments described herein. The electron beam-based output acquisition subsystem configuration described herein may be altered to optimize the performance of the output acquisition subsystem as is normally performed when designing a commercial output acquisition system. In addition, the systems described herein may be implemented using an existing system (e.g., by adding functionality described herein to an existing system). For some such systems, the methods described herein may be provided as optional functionality of the system (e.g., in addition to other functionality of the system). Alternatively, the system described herein may be designed as a completely new system.

Although the output acquisition subsystem is described above as being an electron beam-based output acquisition subsystem, the output acquisition subsystem may be an ion beam-based output acquisition subsystem. Such an output acquisition subsystem may be configured as shown in FIG. 3 except that the electron beam source may be replaced with any suitable ion beam source known in the art. In addition, the output acquisition subsystem may be any other suitable ion beam-based output acquisition subsystem such as those included in commercially available focused ion beam (FIB) systems, helium ion microscopy (HIM) systems, and secondary ion mass spectroscopy (SIMS) systems.

The computer subsystem 302 includes a processor 308 and an electronic data storage unit 309. The processor 308 may include a microprocessor, a microcontroller, or other devices. The processor 308 may be a CPU or a GPU.

The computer subsystem 302 may be coupled to the components of the system 300 in any suitable manner (e.g., via one or more transmission media, which may include wired and/or wireless transmission media) such that the processor 308 can receive output. The processor 308 may be configured to perform a number of functions using the output. The workpiece inspection tool can receive instructions or other information from the processor 308. The processor 308 and/or the electronic data storage unit 309 optionally may be in electronic communication with another workpiece inspection tool, a workpiece metrology tool, or a workpiece review tool (not illustrated) to receive additional information or send instructions.

The processor 308 is in electronic communication with the workpiece inspection tool, such as the detector 307. The processor 308 may be configured to process images generated using measurements from the detector 307. For example, the processor may perform embodiments of the method 100 or the method shown in FIG. 2.

An additional embodiment relates to a non-transitory computer-readable medium storing program instructions executable on a processor for performing a computer-implemented method for image processing, as disclosed herein. In particular, as shown in FIG. 3, electronic data storage unit 309 or other storage medium may contain non-transitory computer-readable medium that includes program instructions executable on the processor 308. The computer-implemented method may include any step(s) of any method(s) described herein, including the method 100 or the method shown in FIG. 2.

The computer subsystem 302, other system(s), or other subsystem(s) described herein may be part of various systems, including a personal computer system, image computer, mainframe computer system, workstation, network appliance, internet appliance, or other device. The subsystem(s) or system(s) may also include any suitable processor known in the art, such as a parallel processor. In addition, the subsystem(s) or system(s) may include a platform with high-speed processing and software, either as a standalone or a networked tool.

The processor 308 and electronic data storage unit 309 may be disposed in or otherwise part of the system 300 or another device. In an example, the processor 308 and electronic data storage unit 309 may be part of a standalone control unit or in a centralized quality control unit. Multiple processors 308 or electronic data storage units 309 may be used.

The processor 308 may be implemented in practice by any combination of hardware, software, and firmware. Also, its functions as described herein may be performed by one unit, or divided up among different components, each of which may be implemented in turn by any combination of hardware, software and firmware. Program code or instructions for the processor 308 to implement various methods and functions may be stored in readable storage media, such as a memory in the electronic data storage unit 309 or other memory.

If the system 300 includes more than one computer subsystem 302, then the different subsystems may be coupled to each other such that images, data, information, instructions, etc. can be sent between the subsystems. For example, one subsystem may be coupled to additional subsystem(s) by any suitable transmission media, which may include any suitable wired and/or wireless transmission media known in the art. Two or more of such subsystems may also be effectively coupled by a shared computer-readable storage medium (not shown).

The processor 308 may be configured to perform a number of functions using the output of the system 300 or other output. For instance, the processor 308 may be configured to send the output to an electronic data storage unit 309 or another storage medium. The processor 308 may be further configured as described herein.

The processor 308 or computer subsystem 302 may be part of a defect review system, an inspection system, a metrology system, or some other type of system. Thus, the embodiments disclosed herein describe some configurations that can be tailored in a number of manners for systems having different capabilities that are more or less suitable for different applications.

The processor 308 may be configured according to any of the embodiments described herein. The processor 308 also may be configured to perform other functions or additional steps using the output of the system 300 or using images or data from other sources.

The processor 308 may be communicatively coupled to any of the various components or sub-systems of system 300 in any manner known in the art. Moreover, the processor 308 may be configured to receive and/or acquire data or information from other systems (e.g., inspection results from an inspection system such as a review tool, a remote database including design data and the like) by a transmission medium that may include wired and/or wireless portions. In this manner, the transmission medium may serve as a data link between the processor 308 and other subsystems of the system 300 or systems external to system 300.

Various steps, functions, and/or operations of system 300 and the methods disclosed herein are carried out by one or more of the following: electronic circuits, logic gates, multiplexers, programmable logic devices, ASICs, analog or digital controls/switches, microcontrollers, or computing systems. Program instructions implementing methods such as those described herein may be transmitted over or stored on carrier medium. The carrier medium may include a storage medium such as a read-only memory, a random access memory, a magnetic or optical disk, a non-volatile memory, a solid state memory, a magnetic tape, and the like. A carrier medium may include a transmission medium such as a wire, cable, or wireless transmission link. For instance, the various steps described throughout the present disclosure may be carried out by a single processor 308 (or computer subsystem 302) or, alternatively, multiple processors 308 (or multiple computer subsystems 302). Moreover, different sub-systems of the system 300 may include one or more computing or logic systems. Therefore, the above description should not be interpreted as a limitation on the present disclosure but merely an illustration.

Generally speaking, deep learning (also known as deep structured learning, hierarchical learning or deep machine learning) is a branch of machine learning based on a set of algorithms that attempt to model high level abstractions in data. In a simple case, there may be two sets of neurons: ones that receive an input signal and ones that send an output signal. When the input layer receives an input, it passes on a modified version of the input to the next layer. In a deep network, there are many layers between the input and output, allowing the algorithm to use multiple processing layers, composed of multiple linear and non-linear transformations.

Deep learning is part of a broader family of machine learning methods based on learning representations of data. An observation (e.g., a feature to be extracted for reference) can be represented in many ways such as a vector of intensity values per pixel or in a more abstract way like a set of edges, regions of particular shape, etc. Some representations are better than others at simplifying the learning task (e.g., face recognition or facial expression recognition).

In an embodiment, the deep learning model is configured as a neural network. In a further embodiment, the deep learning model may be a deep neural network with a set of weights that model the world according to the data that it has been fed to train it. Neural networks can be generally defined as a computational approach based on a relatively large collection of neural units loosely modeling the way a biological brain solves problems with relatively large clusters of biological neurons connected by axons. Each neural unit is connected with many others, and links can be enforcing or inhibitory in their effect on the activation state of connected neural units. These systems are self-learning and trained rather than explicitly programmed and excel in areas where the solution or feature detection is difficult to express in a traditional computer program.

Neural networks typically include multiple layers, and the signal path traverses from front to back. The goal of the neural network is to solve problems in the same way that the human brain would, although several neural networks are much more abstract. Modern neural network projects typically work with a few thousand to a few million neural units and millions of connections. The neural network may have any suitable architecture and/or configuration known in the art.

A neural network for deep learning can be either supervised or unsupervised. A supervised neural network uses labeled data sets during training whereas an unsupervised neural network involves analysis of unlabeled data sets. In an embodiment, a deep learning model may be based on architectures such as residual nets, convolution neural networks, deep belief networks and recurrent neural networks. In an architecture based on convolutions, each layer performs certain convolution operations based on one or more kernels (typically defined by weights associated with the kernels). During the training process, the deep learning model may be modified by adjusting the kernels (i.e. changing the kernel weight values).

A convolutional neural network typically has several layers chained together in a subsequent manner, such that information flows from input to output. Effectively, each layer takes in a tensor Tᵢₙ and outputs a new tensor Tₒᵤₜ. The input tensor is convolved with a kernel tensor W, the resulting convolution may be increased with a bias vector and passed through an activation function such as a rectified linear unit (ReLU). In the present disclosure, one or more dilated kernels may be used to increase the receptive field without doing max-pooling (since it may deteriorate spatial resolution). The dilated kernel is a kernel used with the dilation operation. Typically, a max-pooling is an operation that uses the maximum value from each of a cluster of neurons at the prior layer.

The deep learning model needs to be trained, and object (or features within an image) labels may be domain specific. As such, in an embodiment, a set of training data is generated or obtained based on some ground truth. Such ground truth may include a set of raw input images together with output images, where each pixel has been assigned an object label. By using data augmentation (e.g., taking random crops out of the ground truth and translating, rotating, scaling, etc.) a training set with sufficient variation and volume may be generated.

As used herein, the term “wafer” generally refers to substrates formed of a semiconductor or non-semiconductor material. Examples of such a semiconductor or non-semiconductor material include, but are not limited to, monocrystalline silicon, gallium nitride, gallium arsenide, indium phosphide, sapphire, and glass. Such substrates may be commonly found and/or processed in semiconductor fabrication facilities.

A wafer may include one or more layers formed upon a substrate. For example, such layers may include, but are not limited to, a photoresist, a dielectric material, a conductive material, and a semiconductive material. Many different types of such layers are known in the art, and the term wafer as used herein is intended to encompass a wafer including all types of such layers.

One or more layers formed on a wafer may be patterned or unpatterned. For example, a wafer may include a plurality of dies, each having repeatable patterned features or periodic structures. Formation and processing of such layers of material may ultimately result in completed devices. Many different types of devices may be formed on a wafer, and the term wafer as used herein is intended to encompass a wafer on which any type of device known in the art is being fabricated.

Other types of workpieces also may be used. For example, the workpiece may be used to manufacture LEDs, solar cells, magnetic discs, flat panels, or polished plates. Defects on other objects also may be classified using techniques and systems disclosed herein.

Each of the steps of the method may be performed as described herein. The methods also may include any other step(s) that can be performed by the processor and/or computer subsystem(s) or system(s) described herein. The steps can be performed by one or more computer systems, which may be configured according to any of the embodiments described herein. In addition, the methods described above may be performed by any of the system embodiments described herein.

Although the present disclosure has been described with respect to one or more particular embodiments, it will be understood that other embodiments of the present disclosure may be made without departing from the scope of the present disclosure. Hence, the present disclosure is deemed limited only by the appended claims and the reasonable interpretation thereof.

What is claimed is:

1. A method comprising:
receiving an image of a workpiece at a processor, wherein the image is a scanning electron beam image;
determining a binary segmented image from the image using a supervised deep learning image segmentation model, wherein the binary segmented image is rendered to be binary and is segmented to include only some features of the image;
matching, using the processor, the binary segmented image to a region of a design image, wherein the design image is rendered from a design of structures on the workpiece; and
performing, using the processor, defect detection in the image using the region of the design image.

2. The method of claim 1, further comprising imaging the workpiece with an electron beam workpiece inspection tool.

3. The method of claim 2, further comprising:
generating an electron beam with an electron beam source;
directing the electron beam at the workpiece;
measuring electrons returned from the workpiece using a detector; and
generating, using the processor, the image using signals from the detector.

4. The method of claim 1, further comprising training the supervised deep learning image segmentation model using a plurality of pairs of training images and corresponding training binary segmented images.

5. The method of claim 1, wherein the workpiece is a semiconductor wafer.

6. The method of claim 5, wherein the image includes at least one logic structure.

7. An electron beam workpiece inspection tool comprising:
an electron beam source configured to generate an electron beam;
a stage configured to hold a workpiece in a path of the electron beam;
a detector configured to measure electrons returned from the workpiece; and
a processor in electronic communication with the detector, wherein the processor is configured to:
receive an image of the workpiece, wherein the image is based on signals from the detector;
determine a binary segmented image from the image using a supervised deep learning image segmentation model, wherein the binary segmented image is rendered to be binary and is segmented to include only some features of the image;
match the binary segmented image to a region of a design image, wherein the design image is rendered from a design of structures on the workpiece; and
perform defect detection in the image using the region of the design image.

8. The electron beam workpiece inspection tool of claim 7, wherein the processor is further configured to generate the image using the signals from the detector.

9. The electron beam workpiece inspection tool of claim 7, wherein the supervised deep learning image segmentation model is trained using a plurality of pairs of training images and corresponding training binary segmented images.

10. The electron beam workpiece inspection tool of claim 1, wherein the workpiece is a semiconductor wafer.

11. The electron beam workpiece inspection tool of claim 10, wherein the image includes at least one logic structure.

12. A non-transitory computer-readable storage medium, comprising one or more programs for executing the following steps on one or more computing devices:
receiving an image of a workpiece, wherein the image is a scanning electron beam image;
determining a binary segmented image from the image using a supervised deep learning image segmentation model, wherein the binary segmented image is rendered to be binary and is segmented to include only some features of the image;
matching the binary segmented image to a region of a design image, wherein the design image is rendered from a design of structures on the workpiece; and
performing defect detection in the image using the region of the design image.

13. The non-transitory computer-readable storage medium of claim 12, wherein the steps include sending instructions to an electron beam workpiece inspection tool to image the workpiece.

14. The non-transitory computer-readable storage medium of claim 12, wherein the supervised deep learning image segmentation model is trained using a plurality of pairs of training images and corresponding training binary segmented images.

15. The non-transitory computer-readable storage medium of claim 12, wherein the workpiece is a semiconductor wafer.

16. The non-transitory computer-readable storage medium of claim 15, wherein the image includes at least one logic structure.
